(19) United States
(12) Patent Application Publication
(10) Pub. No.: US 2012/0002214 A1
(43) Pub. Date: Jan. 5, 2012

(54) OPTICAL TOMOGRAPHIC IMAGING APPARATUS AND CONTROL METHOD THEREFOR

(75) Inventors: Norihiko Utsunomiya, Machida-shi (JP); Kazuhide Miyata, Yokohama-shi (JP)

(73) Assignee: CANON LABUSHIKI KAISHA, TOKYO (JP)

(21) Appl. No.: 13/256,528

(22) PCT Filed: Apr. 8, 2010
(86) PCT No.: PCT/JP2010/056724

§ 371 Date: Sep. 14, 2011

(30) Foreign Application Priority Data
Apr. 13, 2009 (JP) 2009-097402

(51) Int. Cl. G01B 11/02

(52) U.S. Cl. 356/498

(57) ABSTRACT

There are provided an optical tomographic imaging apparatus which detects an amount of movement of an object during imaging to reduce a deformation or a displacement in a depth direction in an acquired image. The apparatus using interference beams obtained by combining each return beam with each reference beam, the return beams being obtained by scanning the object with measuring beams, including: a unit adapted to scan the object with the measuring beams; a unit adapted to irradiate the object with the measuring beams such that regions of the object irradiated with each measuring beams are partially overlapped; a unit adapted to calculate a positional difference in a depth direction between obtained tomographic images of the overlapped parts of the regions; and a unit adapted to compute an amount of movement of the object based on the calculated positional difference in the depth direction.

### TECHNICAL FIELD

The present invention relates to an optical tomographic imaging apparatus which captures a tomographic image of an object and a control method for the optical tomographic imaging apparatus and, more particularly, to an optical tomographic imaging apparatus including an interference optical system used in, e.g., ophthalmologic diagnosis and a control method for the optical tomographic imaging apparatus.

### BACKGROUND ART

Various optical instruments are currently used as ophthalmologic instruments.

Among the optical instruments, various instruments such as an anterior ocular segment photographing device, a fundus camera, a confocal scanning laser ophthalmoscope (SLO), and an optical coherence tomography (OCT) which is an optical tomographic imaging apparatus using optical interference by low coherent light are used as optical instruments for observing eyes.

In particular, the optical tomographic imaging apparatus including an OCT system using optical interference by low coherent light is an apparatus for obtaining a tomographic image of a fundus at high resolution. The optical tomographic imaging apparatus is becoming essential for outpatient departments specialized in retina.

Hereinafter, an optical tomographic imaging apparatus including such an OCT system will be referred to as an OCT apparatus.

An OCT apparatus is an apparatus which applies low coherent light to a sample, typified by a retina, and measures light reflected from the sample with high sensitivity using an interferometer. An OCT apparatus can obtain a tomographic image by scanning the low coherent light onto a sample. A tomographic image of a retina, in particular, is widely used for ophthalmologic diagnosis.

When an OCT apparatus performs imaging, the OCT apparatus composes an image by scanning. Accordingly, a deformation or a displacement occurs in an acquired image if an object moves during imaging.

If an object is a human eye, an involuntary eye ball movement called an involuntary eye movement of an eye ball and a movement in a back and forth direction or the like of an eye ball including the whole head cause the problem of the deformation or the displacement in an acquired image.

High-speed scanning is required as a measure to prevent such a deformation, and proposals have been made to this end.

As one of the proposals, National Publication of International Patent Application No. 2008-508068 discloses an OCT apparatus which acquires an image using a plurality of beams.

According to the OCT apparatus, it is possible to make an image recording time shorter than an image recording time for acquisition using a single beam.

Assume a case where a tomographic image of an object is captured using an OCT apparatus, as described above. If the object moves during imaging, especially if an eye ball moves in a back and forth direction or the like, a deformation or a displacement in a depth direction may occur in an acquired image.

Nowadays, reducing the deformation or the displacement in fundus observation or the like is an important issue.

According to the OCT apparatus in National Publication of International Patent Application No. 2008-508068, image acquisition using a plurality of beams enables an image recording time shorter than an image recording time for acquisition using a single beam. However, the apparatus in National Publication of International Patent Application No. 2008-508068 gives no consideration to detecting a movement in a back and forth direction or the like of an eye ball serving as an object and reducing one of a deformation and a displacement in a depth direction in an acquired image.

### DISCLOSURE OF THE INVENTION

The present invention has been made in consideration of the above-described issue, and has as its object to provide an optical tomographic imaging apparatus which detects the amount of movement of an object during imaging in order to reduce a deformation or a displacement in a depth direction of a fundus corresponding to a Z direction in an X-Y-Z coordinate system in an acquired image caused by a movement of the object and a control method for the optical tomographic imaging apparatus.

The present invention provides an optical tomographic imaging apparatus configured in the manner below. The optical tomographic imaging apparatus according to the present invention is an optical tomographic imaging apparatus for capturing a tomographic image of an object using interference beams obtained by combining each return beam with each reference beam, the return beams being obtained by scanning the object with measuring beams, said apparatus comprising: a unit adapted to scan the object with the measuring beams; a unit adapted to irradiate the object with the measuring beams such that regions of the object irradiated with each measuring beams are partially overlapped; a unit adapted to calculate a positional difference in a depth direction between obtained tomographic images of the overlapped parts of the regions; and a unit adapted to compute an amount of movement of the object based on the calculated positional difference in the depth direction.

A control method for an optical tomographic imaging apparatus according to the present invention is a control method for an optical tomographic imaging apparatus which acquires interference beams obtained by combining each return beam with each reference beam, the return beams being obtaining by scanning an object with measuring beams, the method comprising the steps of: scanning the object with the measuring beams such that regions of the object irradiated with each of the measuring beams are partially overlapped; acquiring images of the overlapped parts of the object; calculating a positional difference in a depth direction between the images; and computing an amount of movement of the object based on the calculated positional difference.

According to the present invention, it is possible to realize an optical tomographic imaging apparatus which detects the amount of movement of an object during imaging in order to reduce a deformation or a displacement in a depth direction of a fundus corresponding to a Z direction in an X-Y-Z coordinate system in an acquired image caused by a movement of the object and a control method for the optical tomographic imaging apparatus.

Further features of the present invention will become apparent from the following description of exemplary embodiments with reference to the attached drawings.

### BRIEF DESCRIPTION OF THE DRAWINGS

FIG. 1 is a schematic view for describing the configuration of an optical tomographic imaging apparatus according to an embodiment of the present invention.

FIG. 2 is a view for describing a configuration example according to a first Example of the present invention in which image recording ranges overlap each other.

FIGS. 3A, 3B, and 3C are views for describing an example of acquisition of tomographic images when there is no back and forth movement of an eye ball during acquisition of images, according to the first Example of the present invention.

FIGS. 4A, 4B, and 4C are views for describing an example of acquisition of tomographic images when there is a back and forth movement of an eye ball during acquisition of images, according to the first Example of the present invention.

FIGS. 5A, 5B, and 5C are views for describing an example of acquisition of tomographic images when a subject's eye is displaced in a direction orthogonal to an eye axis during acquisition of images, according to a second Example of the present invention.

FIG. 6 is a block diagram of a low coherent optical tomographic imaging apparatus which embodies the present invention.

FIG. 7 is a flow chart for describing a control flow according to the embodiment of the present invention.

FIG. 8 is a flow chart for describing a control flow according to the second Example of the present invention.

### BEST MODES FOR CARRYING OUT THE INVENTION

An optical tomographic imaging apparatus including an OCT system which captures a tomographic image of an object according to an embodiment of the present invention will be described.

The optical tomographic imaging apparatus according to the embodiment of the present invention splits light which is emitted from a light source and is made up of a plurality of beams into measuring beams and reference beams and uses interference beams obtained by combining return beams obtained when the measuring beams are reflected or scattered from an object and the reference beams which have passed through reference beam paths. The optical tomographic imaging apparatus constitutes a Fourier-domain OCT apparatus.

The OCT apparatus is configured to scan the light made up of the plurality of beams by a scanning unit for scanning in an X-Y coordinate system and irradiate different parts of a fundus of an eye ball which are measured regions of the object.

Positions in the fundus irradiated with the beams are arranged to be spatially divided in a main scanning direction that is an axial direction for high-speed scanning of the OCT apparatus.

A single scanning unit is used as a scanning unit for the main scanning direction for the beams, and scanning angles are set such that image acquisition ranges for the beams have overlapping regions at each boundary part.

A unit is provided to compare acquired images in overlapping regions obtained by beams adjacent in the overlapping regions and calculate a positional difference in a depth direction of a fundus corresponding to a Z direction in an X-Y-Z coordinate system, at the time of image recording.

A unit is further provided to compute the amount of movement of the object from the calculated positional difference in the depth direction between tomographic images in the overlapping regions at the boundary part obtained by the spatial division.

A unit is further provided to change a beam path length for the reference beam in order to reduce a deformation or a displacement in the depth direction in an acquired image caused by a movement of the object, based on the computed amount of movement of the object.

As described above, in the present embodiment, image acquisition parts for the plurality of beams are arranged by spatial division in the main scanning direction. If data with the same number of pixels is acquired, a scanning speed can be increased. The present embodiment is configured to use a depth difference between overlapping regions of the beams.

Accordingly, an involuntary eye movement and a back and forth movement of an eye ball can be measured at high speed without an additional measurement unit, which enables correction of a reference beam path length in acquiring a tomographic image of a fundus.

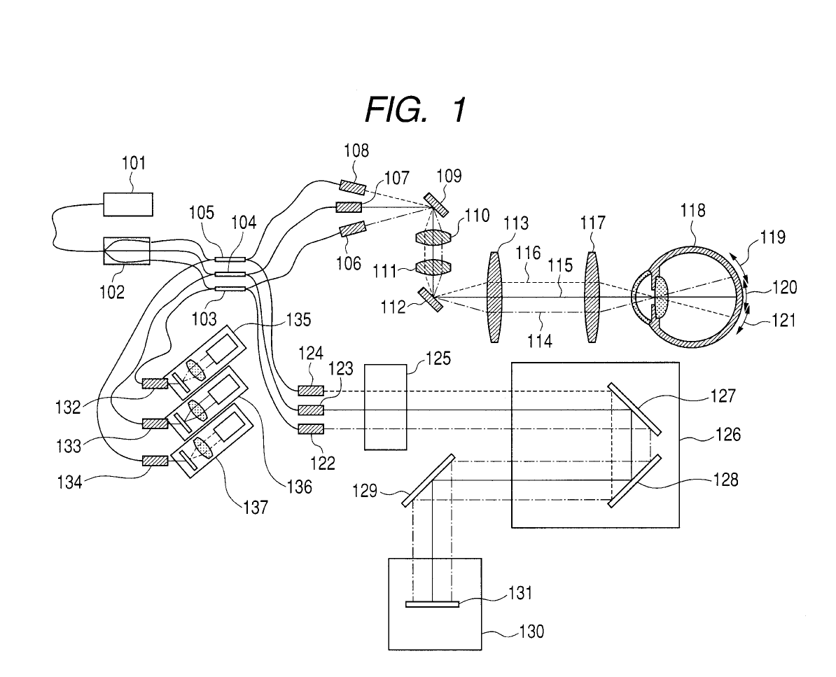

The specific configuration of an OCT apparatus according to the present embodiment will be described with reference to FIG. 1.

Light emitted from a light source 101 which emits low coherent light passes through an optical fiber. The light is separated into a plurality of beams by a beam splitter 102.

Each beam is split into a reference beam and a measuring beam by corresponding fiber couplers 103, 104, and 105.

The separated measuring beams are guided to a scanning optical system by fiber collimators 106, 107, and 108, respectively.

The measuring beams emitted from the fiber collimators 106, 107, and 108 are scanned in a main scanning direction by a galvano scanner 109.

The measuring beams are then guided to a galvano scanner 112 for a sub-scanning direction by lenses 110 and 111. The scanners 109 and 112 are arranged to be in conjugate relation with each other by the lenses 110 and 111.

The measuring beams are guided by lenses 113 and 117 such that the measuring beams intersect at a pupil of a subject's eye 118 and are focused at a fundus of the eye 118 to be inspected. In this case, the separated measuring beams cover scan areas indicated by arrows 119, 120, and 121, respectively.

A scanning direction indicated by the arrows 119, 120, and 121 is the main scanning direction of the galvano scanner 109, and acquired image ranges for the beams are obtained by spatial division in the main scanning direction.

The reference beams split by the fiber couplers 103, 104, and 105 are converted into collimated beams by fiber collimators 122, 123, and 124 and pass through a dispersion compensating glass 125.

The reference beams are guided to a mirror 131 on a high-speed reference beam path length changing stage 130 by mirrors 127 and 128 on a stage 126 for changing a reference beam path length and a mirror 129.

The measuring beams and the reference beams follow the same paths back to the fiber couplers 103, 104, and 105, and each measuring beam and the reference beam corresponding to the measuring beam are combined therein.

Interference beams obtained by the combining are emitted from fiber collimators 132, 133, and 134 and are guided to spectroscopes 135, 136, and 137. The intensities of the interference beams are detected, thereby generating tomographic images.

Next the details of components used in the optical tomographic imaging apparatus according to the present embodiment will be described.

A light source used as the low coherent light source 101 is desirably with low temporal coherence and high spatial coherence. A super luminescent diode, an amplified spontaneous emission (ASE) light source, a femtosecond laser source, or a swept source laser is suitably used.

If a swept source laser is used, photodiodes are used as the spectroscopes 135, 136, and 137.

Although Michelson type interferometers are used in the above description, both of a Michelson type interferometer and a Mach-Zehnder type interferometer can be used.

An interferometer light path may be configured to be open to the air and may, of course, be configured using an optical fiber optical system as above described configuration.

As a method for making the beam path length of a reference beam path variable, the process of making the beam path length of light open to the air variable by a mirror mounted on a stage is suitably used.

The present embodiment adopts a configuration with two stages, the long working distance stage 126 for accommodating variations among eyes to be inspected and the short working distance, fast response stage 130.

As an approach to imaging a fundus of a subject's eye as a tomographic image, any of a Fourier-domain approach, a spectral-domain approach, and a swept-source approach is available.

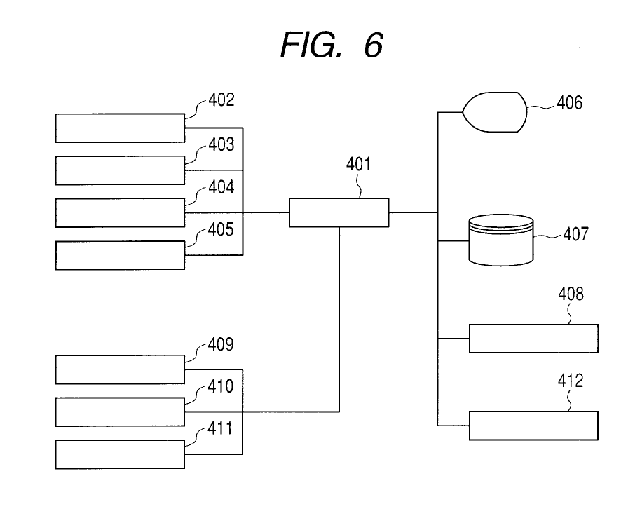

The configuration of a control section in the optical tomographic imaging apparatus according to the present embodiment will be described with reference to FIG. 6.

Reference numeral 401 denotes a central processing unit (CPU). Reference numeral 402 denotes a scanner driver which controls the scanner for the X direction, which is the main scanning direction.

Reference numeral 403 denotes a scanner driver for controlling the scanner for the Y direction, which is the sub-scanning direction.

Reference numeral 404 denotes a stage controller which controls the stage configured to change reference beam paths for adjusting a position in a depth direction (the Z direction) of a fundus for each test object.

Reference numeral 405 denotes a controller for a tracking stage serving as a reference beam path length changing unit for tracking a back and forth movement of an eye ball during acquisition of a fundus tomographic image.

Reference numerals 409, 410, and 411 denote line sensors for the spectroscopes configured to acquire spectral-domain OCT signals.

Reference numeral 406 denotes a display which is in charge of result display and a user interface to be manipulated by a tester.

Reference numeral 407 denotes a hard disk drive (HDD) for storing an operating program and an imaging result.

Reference numeral 408 denotes a main memory (RAM) for loading a program during operation and temporarily storing data during operation.

The control section in the optical tomographic imaging apparatus according to the present embodiment includes the above-described components and controls the components in FIG. 1.

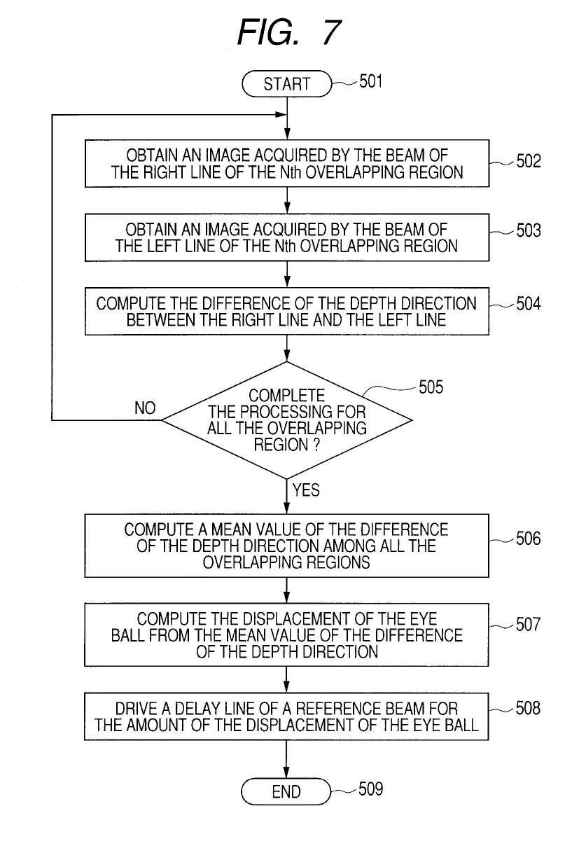

Next, a first control flow according to the present embodiment will be described with reference to the flow chart shown in FIG. 7.

The control flow is executed by the control section shown in FIG. 6 at a timing that an image is acquired.

First, in step 501, processing starts.

The processes in steps 502, 503, and 504 are repeated for times as much as the number of sets of beam overlapping regions (the number of beams in the main scanning direction minus 1).

More specifically, in the process in step 502, an image acquired by a beam on the right side of images in the Nth (N represents a loop count) sets of overlapping regions is obtained.

In the process in step 503, an image acquired by a beam on the left side of the images in the Nth (N represents a loop count) sets of overlapping regions is obtained.

A positional difference in the depth direction corresponding to the Z direction in the X-Y-Z coordinate system is calculated from the image obtained in step 502 and the image obtained in step 503 by the process in step 504.

In step 505, it is checked whether processing is completed for all of the sets of overlapping regions. In step 506, a mean value is calculated from differences in the depth direction among all the sets of overlapping regions calculated in step 504.

In step 507, the amount of displacement of an eye ball is calculated from the mean value calculated in step 506.

In step 508, a delay line for a reference beam is driven by the amount of displacement of the eye ball calculated in step 507.

### EXAMPLES

Examples of the present invention will now be described.

### First Example

A first example will describe an optical tomographic imaging apparatus (OCT apparatus) including an OCT system to which the present invention is applied.

As the OCT apparatus according to the present example, an OCT apparatus with the same basic configuration as the OCT apparatus according to the above-described embodiment of the present invention shown in FIG. 1 is used.

In the present example, an SLD light source with a center wavelength of 840 nm and a wavelength width of 50 nm is used as a low coherent light source 101.

Light emitted from the light source 101 passes through an optical fiber and is separated into a plurality of beams using a fiber beam splitter 102.

A 1:3 splitter is used as the fiber beam splitter 102. The plurality of beams is split into reference beams and measuring beams by fiber couplers 103, 104, and 105.

The separated measuring beams are guided to a scanning optical system by fiber collimators 106, 107, and 108.

The measuring beams emitted from the fiber collimators 106, 107, and 108 enter a galvano scanner 109 at respective angles. The galvano scanner 109 is designed to scan an object in a main scanning direction.

The measuring beams are further guided to a galvano scanner 112 for a sub-scanning direction by lenses 110 and 111.

The scanners 109 and 112 are arranged to be in conjugate relation with each other by the lenses 110 and 111.

The measuring beams are guided by lenses 113 and 117 such that the measuring beams intersect at a pupil of a subject's eye 118 and are focused at a fundus of the eye 118 to be inspected. In this case, the separated measuring beams cover scan areas indicated by arrows 119, 120, and 121, respectively.

A scanning direction indicated by the arrows 119, 120, and 121 is the scanning direction of the galvano scanner 109. Acquired image ranges for the beams are obtained by spatial division in the main scanning direction, and the acquired image ranges are configured to overlap in the main scanning direction.

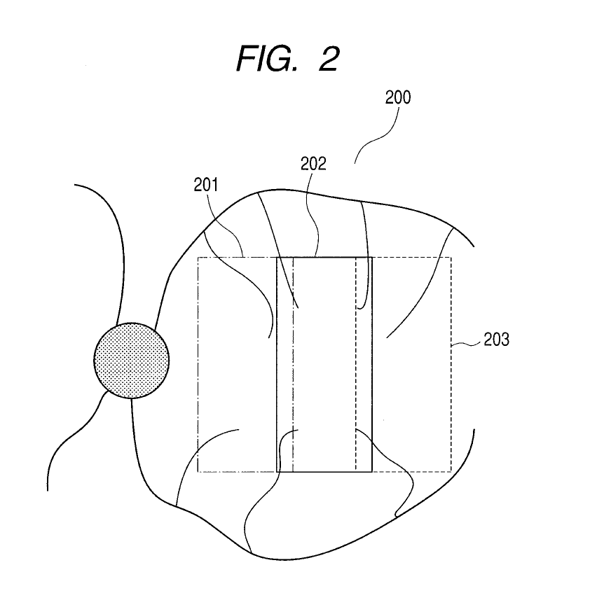

FIG. 2 shows a schematic view of the overlap.

Reference numeral 200 denotes a two-dimensional fundus image.

A region 201 is a recording range for a three-dimensional image corresponding to a scan area indicated by the arrow 119 in FIG. 1.

Similarly, a region 202 is an image recording range corresponding to a scan area indicated by the arrow 120, and a region 203 is an image recording range corresponding to a scan area indicated by the arrow 121.

As shown in FIG. 2, the image recording ranges include overlapping regions. The main scanning direction in FIG. 2 is the lateral direction.

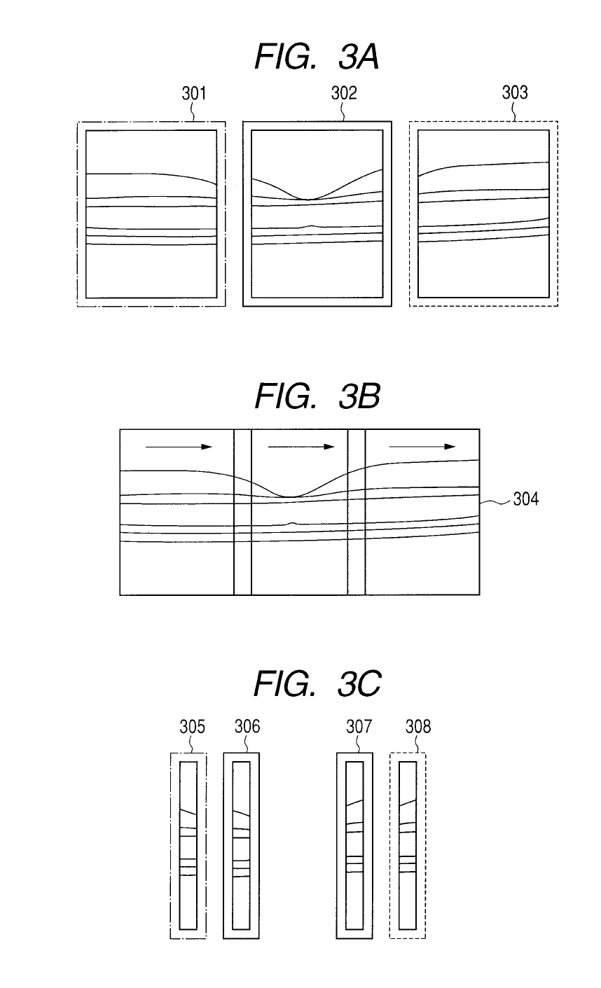

Images of tomographic images are as shown in FIGS. 3A and 3B. The tomographic images, an acquired image 301, an acquired image 302, and an acquired image 303 correspond to the region 201, the region 202, and the region 203, respectively.

The main scanning direction is a direction indicated by arrows in an acquired tomographic pattern 304, as shown in FIG. 3B.

The reference beams split by the fiber couplers 103, 104, and 105 are converted into collimated beams by fiber collimators 122, 123, and 124 and pass through a dispersion compensating glass 125. The reference beams pass through mirrors 127 and 128 on a stage 126 for changing a reference beam path length and are further guided to a mirror 131 on a high-speed reference beam path length changing stage 130.

In the present example, a stepping motor-driven stage using ball screws which can achieve a long working distance is used as the stage 126.

The stage 130 is a voice coil motor-driven, fast response stage.

The measuring beams and the reference beams follow the same paths back to the fiber couplers 103, 104, and 105. Each measuring beam and the reference beam corresponding to the measuring beam are combined. Interference beams obtained by the combining are emitted from fiber collimators 132, 133, and 134 and are guided to spectroscopes 135, 136, and 137. Each of interference spectra acquired by the spectroscopes 135, 136, and 137 is subjected to a Fourier transform and is converted into a tomographic image by a control section shown in FIG. 6.

The Fourier transform is a basic processing method in a Fourier-domain OCT apparatus, and there have been a large number of reports on the Fourier transform. A description of the Fourier transform thus will be omitted.

Next, the configuration of a control section in the OCT apparatus according to the present example will be described.

A control section with the same configuration as the control section according to the embodiment of the present invention shown in FIG. 6 is basically used as the control section according to the present example.

A control program in the control section according to the present example is stored in a hard disk drive 407. The control program is loaded into a main memory 408 when the OCT apparatus is activated.

A manipulation by a tester is performed through an user interface (UI) 412.

In the present example, a keyboard and a mouse are connected thereto.

A display 406 is provided with a graphical user interface to enable an image acquisition start instruction and an image recording instruction to be provided on a screen using the user interface 412.

When an image recording instruction is provided, a main scanner driver 402 and a sub-scanner driver 403 control the scanners according to scan waveforms.

Actually a three-dimensional tomographic image is acquired, but for simplicity of illustration, a single B-scan image recording operation (one main scanning image recording operation) will be described.

When the main scanning scanner 402 performs a one pass scan of a scan area, three line sensors 409, 410, and 411 can acquire interference spectra of a range corresponding to a B-scan in one direction.

Each of the data is subjected to a Fourier transform and is converted into a tomographic image. Data as the tomographic images are the images in FIG. 3A. The line sensors can acquire the images 301, 302, and 303, respectively.

The three images are acquired by beams spatially split in the main scanning direction and have overlapping regions. Accordingly, the acquired tomographic pattern 304 as in FIG. 3B is actually obtained.

FIGS. 3A, 3B, and 3C show an example of a case where there is no back and forth movement of an eye ball of a subject during image acquisition.

For this reason, the tomographic images have no positional difference in a depth direction of the images (the vertical direction of the images) in the overlapping regions in FIG. 3B.

Next, a case where there is a displacement in an image will be described.

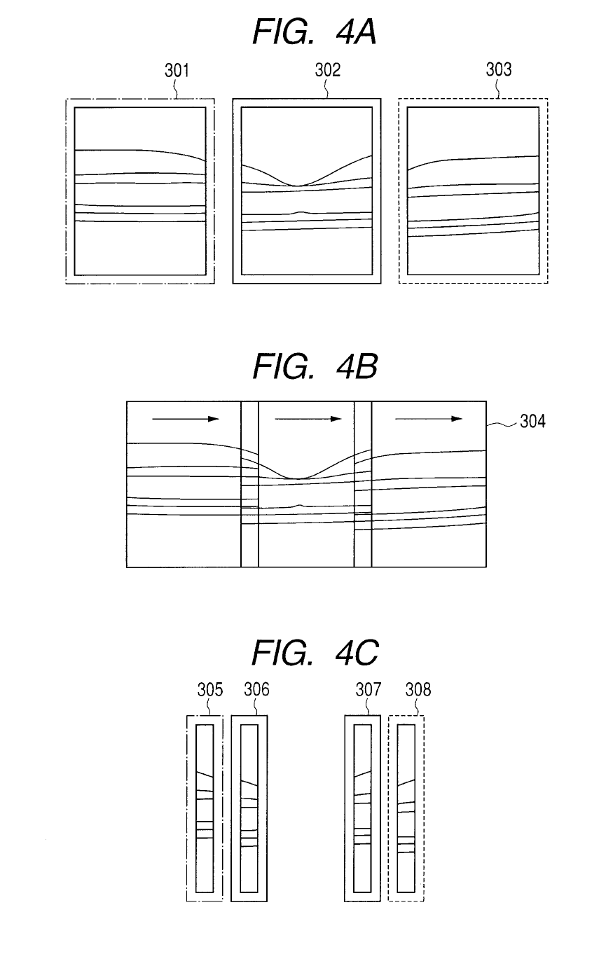

An example of tomographic image acquisition when there is an actual back and forth movement of an eye ball will be described with reference to FIGS. 4A, 4B, and 4C.

FIGS. 4A, 4B, and 4C are examples of acquired images when the subject's eye is approaching the tomographic imaging apparatus during taking the images.

In FIG. 4B, the scanning direction is as shown in the acquired tomographic pattern 304, and images are recorded from left to right.

In this case, overlapping regions of the regions 301 and 302 are a region 305 and a region 306, respectively (FIG. 4C).

The region 305 is recorded at the end of scanning of the region 301.

The region 306 is recorded at the beginning of scanning of the region 302. The regions 301 and 302 are images obtained through scanning by the same scanning unit, i.e., a scanner 109 in FIG. 1, while beams used are different.

Images in the regions 305 and 306 are compared with each other in a depth direction. Since the image in the region 305 is acquired later, the tomographic image has an upward displacement.

In contrast, in FIG. 3C where the tomographic images have no positional difference in the depth direction (the vertical direction of the images), the tomographic images in the regions 305 and 306 have no displacement.

That is, the amount of displacement indicates the amount by which the subject's eye moves in a back and forth direction during a period from when the tomographic image in the region 306 is acquired to when the tomographic image in the region 305 is acquired.

The same applies to a region 307 and a region 308 which are overlapping regions of the regions 302 and 303.

An actual correction sequence will be described with reference to FIG. 7.

The control flow is executed by the control section in FIG. 6 described above when images for one main scan are acquired.

First, in step 501, processing starts.

In the process in step 502, an image acquired by a beam on the right side of images in the Nth (N represents a loop count) sets of overlapping regions is obtained.

The image corresponds to the image in the region 306 in FIG. 4C.

In the process in step 503, an image acquired by a beam on the left side of the images in the Nth (N represents a loop count) sets of overlapping regions is obtained. The image corresponds to the image in the region 305 in FIG. 4C.

A positional difference in the depth direction corresponding to the Z direction in the X-Y-Z coordinate system is calculated by the process in step 504, from the image obtained in step 502 and the image obtained in step 503.

In step 505, it is checked whether processing is completed for all of the sets of overlapping regions. Since the present example adopts a three-beam configuration, processing is performed for two sets of overlapping regions.

In step 506, a mean value is calculated from differences in the depth direction among all the sets of overlapping regions calculated in step 504.

In step 507, the amount of displacement of an eye ball is calculated from the mean value calculated in step 506.

As a method for calculating the amount of displacement, for example, the amount of vertical displacement in a fundus image when a model eye is displaced by a unit length may be calculated in advance, and conversion may be performed using the amount of vertical displacement.

In step 508, the reference beam path length changing stage 130 for tracking in FIG. 1 is driven using a tracking stage controller 405 based on the calculated amount of eye ball displacement.

With the control flow, the tracking stage can be driven each time scanned images for one pass are acquired. Then, it is possible to perform image recording with stability, i.e., with a small amount of vertical displacement in an image, even when a subject's eye moves in the back and forth direction.

### Second Example

A second example will describe an example of a case where a subject's eye is displaced in a direction orthogonal to an eye axis direction during imaging.

Since an OCT apparatus with the same overall configuration and the same control section configuration as the OCT apparatus according to the first example is used as an OCT apparatus according to the present example, a description of the OCT apparatus will be omitted.

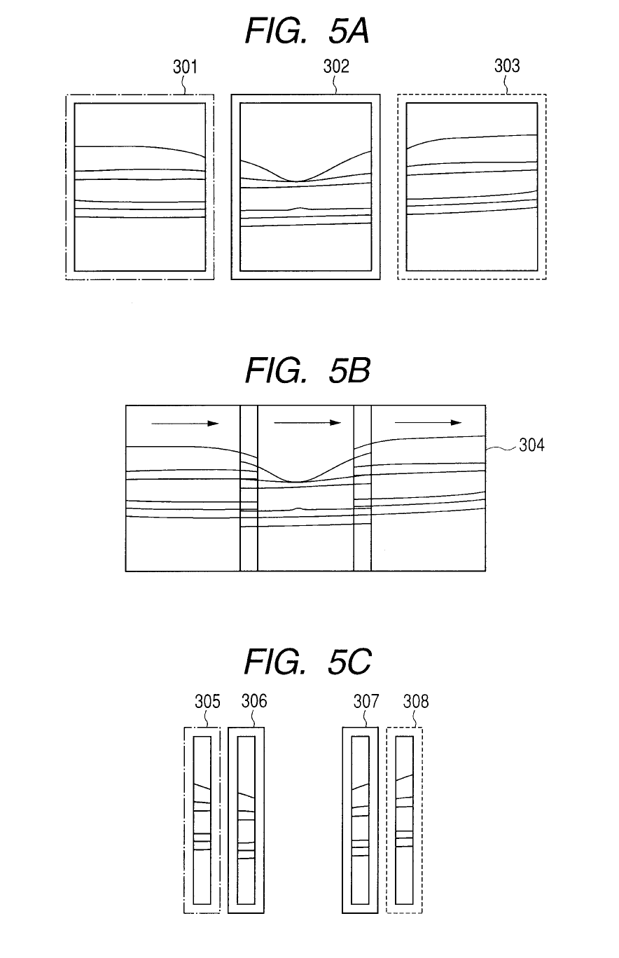

Acquired images when there is an actual back and forth movement of an eye ball will be described with reference to FIGS. 5A, 5B, and 5C. FIGS. 5A, 5B, and 5C show examples of acquired images when a subject's eye is moving in a direction orthogonal to an eye axis (a main scanning direction) with respect to the tomographic imaging apparatus during photography.

In FIG. 5B, a scanning direction is as shown in a tomographic acquisition pattern 304, and images are recorded from left to right. In this case, overlapping regions of regions 301 and 302 are a region 305 and a region 306, respectively. The region 305 shown in FIG. 5C is recorded at the end of scanning of the region 301, and the region 306 is recorded at the beginning of scanning of the region 302. Similarly, overlapping regions of the region 302 and a region 303 are a region 307 and a region 308, respectively. The region 307 shown in FIG. 5C is recorded at the end of scanning of the region 302, and the region 308 is recorded at the beginning of scanning of the region 303.

The regions 301 and 302 are images obtained through scanning by the same scanning unit, i.e., a scanner 109 in FIG. 1, while beams used are different.

A difference in a depth direction between images in the regions 305 and 306 and a difference in the depth direction between images in the regions 307 and 308 are calculated.

From the regions 305 and 306, it can be seen that the content of a tomographic image is displaced upward with time.

From the regions 307 and 308, it can be seen that the content of an image is displaced downward with time.

Since the amount of displacement in an image depends on the region, it is apparent that the content of a tomographic image can be detected to be inclined with time.

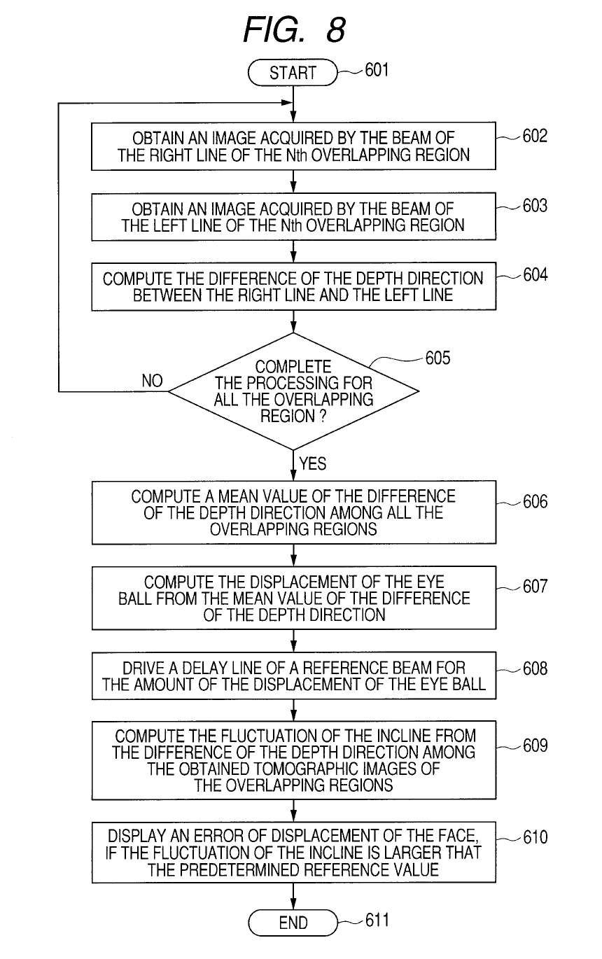

An actual correction sequence will be described here with reference to FIG. 8.

The control flow is executed by a control section in FIG. 6 described above when images are acquired.

First, in step 601, processing starts.

In the process in step 602, an image acquired by a beam on the right side of images in the Nth (a loop count) sets of overlapping regions is obtained. In the case of the first loop, the image corresponds to the region 306 in FIG. 5C.

In the process in step 603, an image acquired by a beam on the left side of the images in the Nth (the loop count) sets of overlapping regions is obtained. The image corresponds to the region 305 in FIG. 5C.

A positional difference in the depth direction corresponding to the Z direction in the X-Y-Z coordinate system is computed from the image obtained in step 602 and the image obtained in step 603 by the process in step 604.

In step 605, it is checked whether processing is completed for all of sets of overlapping regions. Since the present example adopts a three-beam configuration, processing is performed for two sets of overlapping regions.

In step 606, a mean value is calculated from differences in the depth direction among all the sets of overlapping regions calculated in step 604.

In step 607, the amount of displacement of an eye ball is computed from the mean value calculated in step 606.

As a method for calculating the amount of displacement, for example, the amount of vertical displacement in a fundus image when a model eye is displaced by a unit length may be calculated in advance, and conversion may be performed using the amount of vertical displacement. In step 608, a reference beam path length changing stage 130 for tracking in FIG. 1 is driven using a tracking stage controller 405 shown in FIG. 6 based on the calculated amount of eye ball displacement.

Further, in the present example, a fluctuation of an incline is computed from differences in the depth direction among tomographic images in a plurality of sets of overlapping regions in step 609.

If the amount of incline is larger than a predetermined reference value, a tester is notified to that effect by a unit which displays a notification in step 610.

Although only notification to a tester is performed in the present example, an OCT apparatus may be configured to be capable of automatically acquiring a tomographic image again and may perform the process of automatically acquiring a tomographic image again.

An incline during acquisition of three-dimensional data of a tomographic image contributes to the difficulty in creation of three-dimensional volume data. Application of the present example enables the process of appropriately acquiring a tomographic image again before execution of three-dimensional construction.

### OTHER EXAMPLES

Aspects of the present invention can also be realized by a computer of a system or apparatus (or devices such as a CPU or MPU) that reads out and executes a program recorded on a memory device to perform the functions of the above-described example(s), and by a method, the steps of which are performed by a computer of a system or apparatus by, for example, reading out and executing a program recorded on a memory device to perform the functions of the above-described example(s). For this purpose, the program is provided to the computer for example via a network or from a recording medium of various types serving as the memory device (e.g., computer-readable medium).

While the present invention has been described with reference to exemplary examples, it is to be understood that the invention is not limited to the disclosed exemplary examples. The scope of the following claims is to be accorded the broadest interpretation so as to encompass all such modifications and equivalent structures and functions.

This application claims the benefit of Japanese Patent Application No. 2009-097402, filed Apr. 13, 2009, which is hereby incorporated by reference herein in its entirety.

1. An optical tomographic imaging apparatus for capturing a tomographic image of an object using interference beams obtained by combining each return beam with each reference beam, the return beams being obtained by scanning the object with measuring beams, said apparatus comprising:
a unit adapted to scan the object with the measuring beams;
a unit adapted to irradiate the object with the measuring beams such that regions of the object irradiated with each measuring beams are partially overlapped;
a unit adapted to calculate a positional difference in a depth direction between obtained tomographic images of the overlapped parts of the regions;
and a unit adapted to compute an amount of movement of the object based on the calculated positional difference in the depth direction.

2. The optical tomographic imaging apparatus according to claim 1, further comprising
a unit adapted to change a beam path length for the reference beams based on the calculated amount of movement.

3. The optical tomographic imaging apparatus according to claim 1, wherein
said unit adapted to calculate a positional difference calculates the positional difference by comparing the overlapped parts of tomographic images generated based on each of the interference beams.

4. The optical tomographic imaging apparatus according to claim 1, wherein both of the measuring beams and the reference beams consist of three or more beams, said unit adapted to calculate a positional difference calculates a plurality of positional differences, and said unit adapted to compute the amount of movement of the object computes an amount of incline of the object based on the plurality of the positional differences.

5. The optical tomographic imaging apparatus according to claim 4, further comprising a unit adapted to display a message if the amount of incline is larger than a predetermined value.

6. The optical tomographic imaging apparatus according to claim 4, wherein the apparatus is configured to be capable of automatically acquiring a tomographic image of the object again if the amount of incline is larger than a predetermined value.

7. The optical tomographic imaging apparatus according to claim 1, wherein the object is an eyeball, and the positional difference occurs by at least one of an involuntary eye movement and a back and forth movement of the eyeball.

8. A control method for an optical tomographic imaging apparatus which acquires interference beams obtained by combining each return beam with each reference beam, the return beams being obtaining by scanning an object with measuring beams, the method comprising the steps of:
scanning the object with the measuring beams such that regions of the object irradiated with each of the measuring beams are partially overlapped;
acquiring images of the overlapped parts of the object;
calculating a positional difference in a depth direction between the images;
and computing an amount of movement of the object based on the calculated positional difference.
